(19) United States
(12) Patent Application Publication
(10) Pub. No.: US 2011/0277280 A1
(43) Pub. Date: Nov. 17, 2011

(54) Clamping Device

(75) Inventors: Dirk Jan Blaauw, Heidelberg (DE); Detlev Ulle, Ostheim (DE)

(73) Assignee: Delaware Capital Formation, Inc., Wilmington, DE (US)

(21) Appl. No.: 13/112,073

(22) Filed: May 20, 2011

Related U.S. Application Data
(63) Continuation of application No. PCT/DE2010/001286, filed on Nov. 8, 2010.

(30) Foreign Application Priority Data
Nov. 23, 2009 (DE) 102009054153.5

(51) Int. Cl. F16B 2/06

(52) U.S. Cl. 24/568

(57) ABSTRACT

A clamping device has a clamping head piece with a linearly movable actuator in the clamping head piece. Two positional transducers are coupled with the actuating element. The two position transducers are adjustable with respect to one another. Two sensors cooperate with the two positional transducers. The two sensors are arranged at a fixed distance from one another. The two transducers are immovable with respect to the clamping head piece. A separate external access insertion opening is provided in the clamping head piece for each sensor.

### CROSS-REFERENCE TO RELATED APPLICATIONS

This application is a continuation of International Application No. PCT/DE2010/001286, filed Nov. 8, 2010, which claims priority to German Application No. 10 2009 054 153.5, filed Nov. 23, 2009. The disclosures of the above applications are incorporated herein by reference.

### FIELD

The disclosure relates to a clamping device and, more particularly, to a clamping device with an opening that provides external access to the sensors inside the clamping head piece.

### BACKGROUND

A clamping device of the kind described in the introduction is known from German Patent DE 102 56 385 B3. This clamping device consists of a clamping head piece where an actuating element, that is displaceable in a linear manner, is arranged with two position transducers that are adjustable relative to one another. The two position transducers are constructed to cooperate with two transducers disposed at a fixed distance from one another and immovable with respect to the clamping head piece. In this solution, the actuating element, that is displaceable in a linear manner, is constructed in two parts. Further, it is constructed in such a way to have a variable length via a corresponding tooth system. Each position transducer is disposed on one of the parts. The distance between the position transducers is determined by displacement of the parts relative to one another. In the solution according to DE 102 56 385 B3, both transducers are also arranged in a fixed manner on a carrier element, positioned in the clamping head piece. In order to replace the transducers, the entire clamping device has to be disassembled.

A clamping device is also known from German Patent DE 196 16 441 C1. It includes an adjustment mechanism (particularly a toggle lever mechanism) with the actuating element in the clamping head piece for pivotable operation of a clamping arm. A drive unit, for example a pneumatic drive unit, is attached to the actuating element at the end of the clamping head piece farthest from the clamping arm.

Unlike the solution described in DE 102 56 385 B3, the actuating element in the solution of DE 196 16 441 C1 is constructed as a single part and also has only a one position transducer. In order to be able to adapt the clamping device to various clamping requirements, the two transducers are designed to be displaceable relative to one another inside a cassette that can be inserted into a slot on the clamping head piece.

### SUMMARY

It is an object of the disclosure to improve a claming device of the kind described in the introduction.

The object is solved by a clamping device comprising a clamping head piece. An actuating element, movable in a linear manner, is arranged in the clamping head piece. Two position transducers are coupled with the actuating element, the two position transducers are adjustable with respect to one another. Two sensors cooperate with the two position transducers. The two sensors are arranged at a fixed distance from one another. The two sensors are immovable with respect to the clamping head piece. A separate, externally accessible insertion opening is provided on the clamping head piece for each sensor.

According to the disclosure, a separate insertion aperture is accessible from the outside. The aperture is provided on the clamping head piece for each individual transducer.

Thus, the disclosure is particularly distinguished by a departure from the previous clamping devices, usually carrier and cassette designs, in favor of individual positioning of the transducers. A particular advantage of the solution according to the disclosure is that the transducer arrangement is overall significantly less expensive but still sufficiently easy to manage. With regard to manageability, it should be noted that it is almost entirely unnecessary to remove and refit the transducers unless they become damaged. Adaptation to different clamping requirements, for example different opening angles of the clamping arm, is effected by moving the position transducers relative to one another. Accordingly by adjusting the length of the actuating element, as explained in the introduction, a design according to a preferred embodiment of the disclosure is adjustable in length.

Besides electrically operating sensors, that are typically used, it is also possible to use pneumatic sensors. The pneumatic sensors include small directional control valves that are actuated by the position transducers and function as switches.

Other objects and advantages of the clamping device according to the disclosure will become apparent.

The clamping device according to the disclosure as well as its advantageous developments, will be explained in greater detail in the following with reference to the graphical representation of a preferred embodiment.

Further areas of applicability will become apparent from the description provided herein. The description and specific examples in this summary are intended for purposes of illustration only and are not intended to limit the scope of the present disclosure.

### DRAWINGS

The disclosed clamping device and its advantageous embodiments are described in greater detail below with reference to drawings of exemplary embodiments that are viewed from the flank side.

FIG. 1 is a perspective view of the clamping device according to the disclosure with an open clamping head.

FIG. 2 is an elevation view of the clamping device of FIG. 1 viewed from the open side.

### DETAILED DESCRIPTION

The illustrated clamping device includes a clamping head piece 1 with an actuating element 2 that is displaceable in a linear manner. Two position transducers 3, 4, that are adjustable with respect to one another, are positioned in the clamping head piece 1. The two position transducer 3, 4 cooperate with two sensors 5, 6 that are disposed at a fixed distance from one another. The two sensors 5, 6 are immobile (stationary) relative to clamping head piece 1. As is usual, a (pneumatic or hydraulic) piston drive unit 22 is connected to clamping head piece 1, via a flange. The piston drive unit 22 serves to operate the actuating element 2 and an associated control mechanism 16.

In a clamping device of this kind, it is essential that a separate, externally accessible insertion opening 7, 8 is provided on clamping head piece 1 for each sensor 5, 6.

The two sensors 5, 6 each have an electrically powered sensor unit arranged in a small housing 9. A freely flexible wiring harness 10 connects the sensors 5, 6 to a connecting adapter 15, arranged on the clamping head piece 1. The previously mentioned insertion openings 7, 8, on the clamping head piece 1, are constructed so as to conform with the housings 9 of sensors 5, 6. In addition, latching elements 24 are attached to sensors 5, 6 or the housings 9 in the area of the insertion openings 7, 8 to make the attachment simple and secure.

In order to enable access to the actuating element 2, which, as explained previously, is length-adjustable, a grip opening 11, dimensioned appropriately for this purpose, is provided on the clamping head piece 1 separate from the insertion openings 7, 8. Insertion openings 7, 8 are located in front of and behind the slot-shaped grip opening 11 when viewed in the axial or longitudinal direction of the actuating element 2. Thus, the grip opening 11 is located between the two insertion openings 7, 8.

One externally accessible cutout 12 is provided in each of the fixed locating areas of sensors 5, 6 on the two joinable shell-like halves (half-shell elements 17) of the clamping head piece 1. The cutout 12 enlarges and thus facilitates access to insertion openings 7, 8. The cutouts 12 may also be connected by a longitudinal extension. Thus, the cutouts 12 may form a channel (recess) and also extend to grip opening 11.

Depending upon the specific shape of the clamping head piece 1, insertion openings 7, 8 and/or grip opening 11 may optionally be designed to be accessible from the outside through cutout 12. In which case, the combined cutout design is preferred for reasons that will be explained later.

Cutout 12 is generally designed in such a manner to receive a cover element 13. With consideration for such a covering arrangement, cutouts 12 are preferably combined for the insertion openings 7, 8 and the grip opening 11, as previously mentioned. Thus, it is also possible to route and accommodate wiring parts 10 of sensors 5, 6 under protection of the cover element 13. Accordingly, the cover element 13 is constructed to cover the wiring parts 10 of sensors 5, 6. The cover element 13 is conformed so that it may be inserted into the cutout 12. In addition, a through hole may optionally be provided in the clamping head piece 1 and/or the cover element 13 to connect the wiring elements 10 from the sensors 5, 6 to the adapter 15.

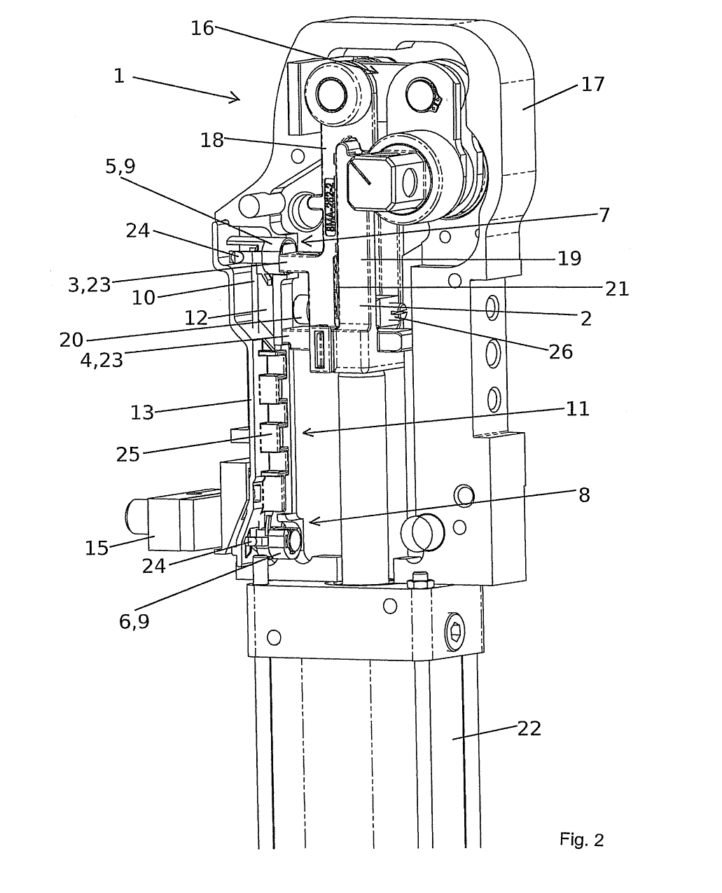

A mating flange surface 14 provided on the clamping head piece 1 is broken up by the elongated cutout 12. Effectively, it provides a wide groove extending transversely on the head piece. Additionally, the entire clamping head piece 1 is attachable to a correspondingly shaped carrier, not shown, via the flange surface 14. As is shown particularly clearly in FIG. 2, the cover element 13, which may be constructed from a suitable plastic, has a cross-sectional shape such that it does not obstruct the mating flange surface 14. The cover element 13 is also provided with stiffening elements 25 on its inside. The stiffening elements 25 engage in the grip opening 11. The cover element 13 may be fixed in position by engaging the clamping head piece 1, as shown in FIG. 2. Alternatively, the cover element 13 may be retained in the cutout 12 with a suitable latching element.

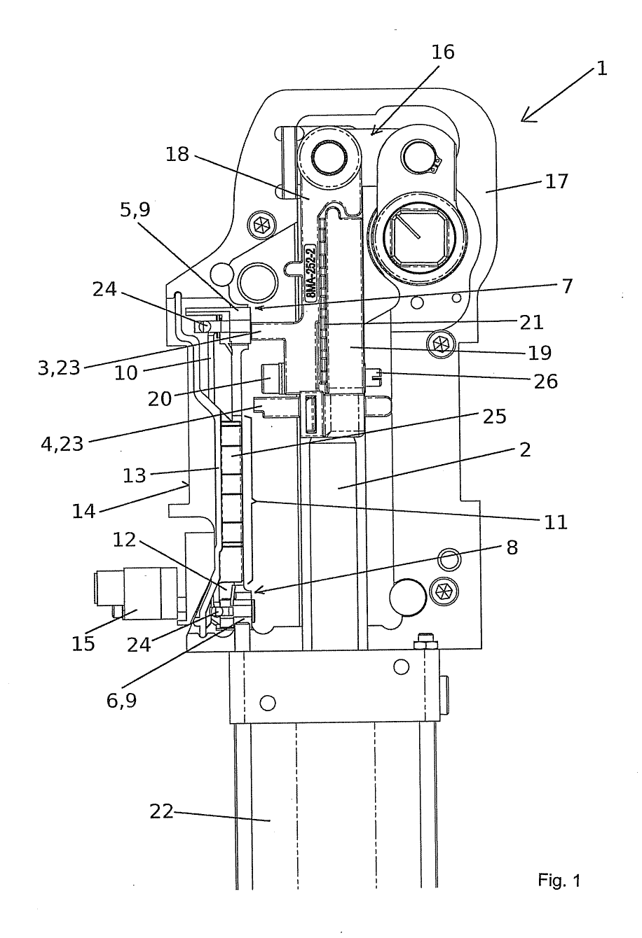

As indicated above, the actuating element 2 is constructed to have an adjustable length. The actuating element 2 includes two locked but detachable parts 18, 19. The parts 18, 19 may be connected to one another. A threaded connection 20, (nut and bolt) 26 (see FIG. 1) pass through apertures in parts 18, 19 to ensure the locked connection between the two. A mutually engaging toothed mechanism 21 is in a desired position connecting the parts 18, 19 with one another. The teeth 21 enable the parts 18, 19 to be extended and retracted with respect to one another to vary their length. The threaded connection is passed through various pairs of apertures to connect the parts 18, 19. Position transducers 3, 4 are arranged on the actuating element 2 or the parts 18, 19, as correspondingly dimensioned projections 23.

With regard to the control mechanism 16, it does not necessarily have to be in the form of a toggle lever mechanism, it may also be constructed as a cam or rocker lever mechanism as described in German Patent No. DE 10 2004 007 465 A1 (FIGS. 3 and 4).

The present disclosure has been described with reference to a preferred embodiment. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A clamping device comprising:
a clamping head piece;
an actuating element, movable in linear manner, is arranged in the clamping head piece;
two position transducers are coupled with the actuating element, the two position transducers are adjustable with respect to one another;
two sensors cooperate with the two position transducers, the two sensors are arranged at a fixed distance from one another, the two sensors are immovable with respect to the clamping head piece; and
a separate, externally accessible insertion opening is provided on the clamping head piece for each sensor.

2. The clamping device in claim 1, wherein the sensor has an electrically powered sensor part, arranged in a housing, and a wiring part.

3. The clamping device in claim 2, wherein the insertion opening is conformed to the shape of the housing of the sensor on the clamping head piece.

4. The clamping device in claim 1, further comprising a grip opening on the clamping head piece for the actuating element.

5. The clamping device in claim 4, wherein the insertion openings are located in front of and behind the grip opening when viewed in an axial direction of the actuating element.

6. The clamping device in claim 1, further comprising a cutout accessible from outside is provided on the clamping head piece.

7. The clamping device in claim 6, wherein the insertion openings and/or a grip opening are optionally constructed so as to be accessible from the outside through the cutout.

8. The clamping device in claim 6, further comprising a cover element insertable into the cutout.

9. The clamping device in claim 8, wherein the cover element covers wiring elements of the sensors in the cutout.

10. The clamping device in claim 6, further comprising a mating flange surface, broken up by the cutout, on the clamping head piece.
